(19) United States
(12) Patent Application Publication
(10) Pub. No.: US 2022/0015307 A1
(43) Pub. Date: Jan. 20, 2022

(54) TEMPORARY ANCHORED, WEATHER COVERING FOR PLANTS

(71) Applicant: Olga KOESTER, Castle Pines, CO (US)

(72) Inventors: Olga KOESTER, Castle Pines, CO (US); Thomas MACK, London (GB)

(21) Appl. No.: 16/930,052

(22) Filed: Jul. 15, 2020

(51) Int. Cl. A01G 13/02; F16B 1/00

(52) U.S. Cl. CPC A01G 13/0212; A01G 2013/0218; F16B 2001/0035; F16B 1/00

(57) ABSTRACT

A rapidly deployable, temporary anchored weather covering for a plant includes a center post, support legs, and anchor legs which are rapidly deployed and temporarily anchored to the ground, around a potted plant, etc. to protect a plant from sudden harsh weather, be it hard rain, hail, heavy snow, even a hot sun, etc. The center post, support legs and anchor legs may be rapidly and temporarily inserted into separable post junctions which include more permanently secured anchoring stakes. Anchoring straps may be included at multiple points with magnetic latches to facilitate rapid deployment. Lower straps may be secured around the underside of a plant pot. The rapidly deployable, temporary anchored weather covering may be undeployed such that the weather covering is furled up, and may be left in place with the center post remaining in the soil, with support legs and anchoring legs and/or anchoring straps retracted.

### BACKGROUND OF THE INVENTION

### 1. Field of the Invention

The invention relates generally to a temporary, anchored weather covering for plants suitable for rapid deployment.

### 2. Background of Related Art

Everyone enjoys plants, whether perennial or annual. Plants in some regions of the world grow year round, while other types of plants are more seasonal in nature. For regions where seasons affect plant growth, a burlap or canvas covering may be installed during the winter to ward off eventual weather, which often does not affect the plant when installed during the plant's dormant season.

Some plants are grown outdoors either in a garden or in a pot. These type plants have the opportunity to thrive outdoors in good weather during their growing season. However, in some regions of the world the change of seasons heading into a growing season may be unpredictable, changing rapidly from hospitable to inhospitable, and back again. Some plants are susceptible to damage or death during an unseasonably harsh period during their growing season, particularly at the start of a growing season when the plants are just emerging from the ground with new leaf growth, etc. If a sudden change occurs in the weather toward the inhospitable, e.g., a sudden hailstorm, or a sudden wind storm, or even a hot sun, some plants may be damaged or killed when subjected to unseasonably cold weather, hailstorms, sudden windstorms, hot sun, etc. during their growing season.

To avoid damage to potted plants, or plants in a garden, conventional methods may be employed to protect the potted plants or garden plants. For instance, a canvas may be wrapped tightly around the plants and encircled in rope to secure the canvas against the plants. A burlap or canvas wrapping may protect larger plants from damage, but is not as practical for smaller or younger plants. Moreover, a burlap or canvas wrap takes a bit of time and planning and so is a more seasonably-permanent solution than a temporary solution commensurate with the length of inhospitable weather. Conventional methods to protect plant life from the weather often requires advance planning and preparation, and takes a significant amount of time and effort to install. Alternatively a more quickly installed protection tends not to be sturdy enough to protect the plant from significant weather, or not to be sufficiently stable in shifting winds. Moreover, depending upon the type of sudden weather, burlap or other breathable materials may not sufficiently protect a plant from the weight and rigors of a sudden hailstorm or from a sudden heavy rain.

### SUMMARY OF THE INVENTION

A rapidly-deployable and temporarily anchoring weather covering for plants according to a first embodiment comprises a deployable weather covering; a strut structure under the deployable weather covering; a plurality of support legs to support an inner area of the strut structure when the deployable weather covering is deployed; and a plurality of anchor legs to temporarily anchor a respective plurality of perimeter anchor points of the deployable weather covering to a ground.

A rapidly-deployable and temporarily anchoring weather covering for plants in accordance with another embodiment of the invention comprises a deployable weather covering; a strut structure under the deployable weather covering; a center post to support the strut structure; a plurality of anchor straps to temporarily anchor a respective plurality of perimeter anchor points of the deployable weather covering to a ground; and a plurality of magnetic latches connected respectively to the plurality of anchor straps; wherein when the deployable weather covering is in a deployed state the plurality of magnetic latches magnetically attach to a respective ferrous mating point.

A rapidly-deployable and temporarily anchoring weather covering for plants according to yet another embodiment comprises a deployable weather covering that deploys in a spiral direction; a strut structure under the deployable weather covering; a center post to support the strut structure; the strut structure including a first split strut and a second split strut which straddle a separation in the deployable weather covering, the first split strut and the second split strut sandwiching the deployable weather covering therebetween in an undeployed state, and the first split strut and the second split strut spiraling around a center post to directly mate with one another in a deployed state; a plurality of anchor legs to temporarily anchor a respective plurality of perimeter anchor points of the deployable weather covering to a ground.

### BRIEF DESCRIPTION OF THE DRAWINGS

Features and advantages of the present invention will become apparent to those skilled in the art from the following description with reference to the drawings, in which:

FIG. 1A shows a cut-away view of an exemplary rapidly deployable, temporary anchored weather covering for a plant, in accordance with a first embodiment of the present invention.

FIG. 1B shows another embodiment of an exemplary rapidly deployable, temporary anchored weather covering for a plant anchored using releasable legs.

FIG. 1C shows the rapidly deployable, temporary anchored weather covering for a plant shown of FIG. 1B but shown in FIG. 1C in an unopened or undeployed state.

FIG. 2 shows exemplary detail of the releasable legs shown in FIGS. 1B and 1C.

FIG. 3 shows telescoping legs of a temporary, anchored weather covering for a plant.

FIG. 4 shows a temporary, anchored weather covering for a plant including flexible anchoring legs, in accordance with another embodiment of the present invention.

FIG. 5 shows a tent-shaped rapidly deployable, temporary anchored weather covering for a plant, in accordance with another embodiment of the present invention.

FIG. 6 shows an unfurled or undeployed state of another exemplary rapidly deployable, temporary anchored weather covering for a plant, in accordance with the present invention.

FIG. 7 shows a top view of attached anchoring straps to anchor a rapidly deployable, temporary anchored weather covering, in accordance with another embodiment of the present invention.

FIG. 8 shows an exemplary rapidly deployable, temporary anchored weather covering including anchoring straps that each have a quick-connect latch, in accordance with another embodiment of the present invention.

FIG. 9 shows further detail of an exemplary temporary quick-connect latch means of the attached anchoring straps shown in FIGS. 7-8.

FIG. 10 shows further detail of another exemplary latch of the attached anchoring straps shown in FIGS. 7-8.

FIGS. 11A and 11B show another temporary, anchored weather covering for a plant having a rotating unfurl function, in accordance with yet another embodiment of the present invention.

### DETAILED DESCRIPTION OF ILLUSTRATIVE EMBODIMENTS

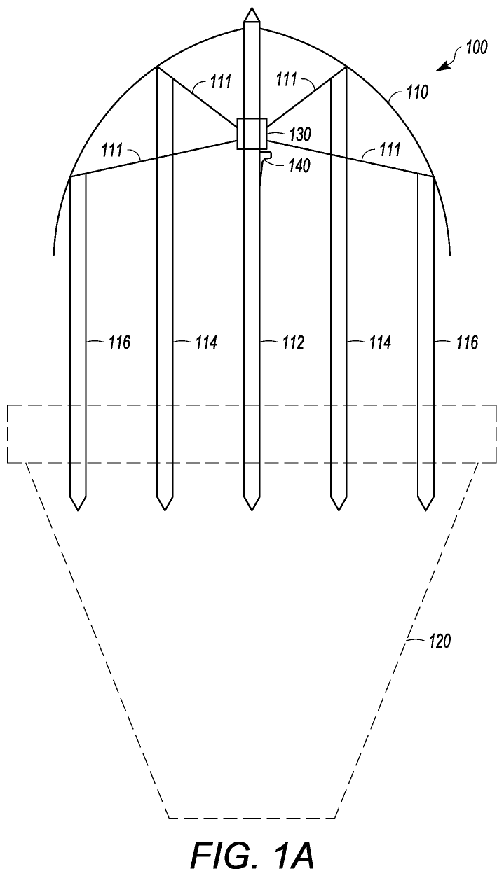

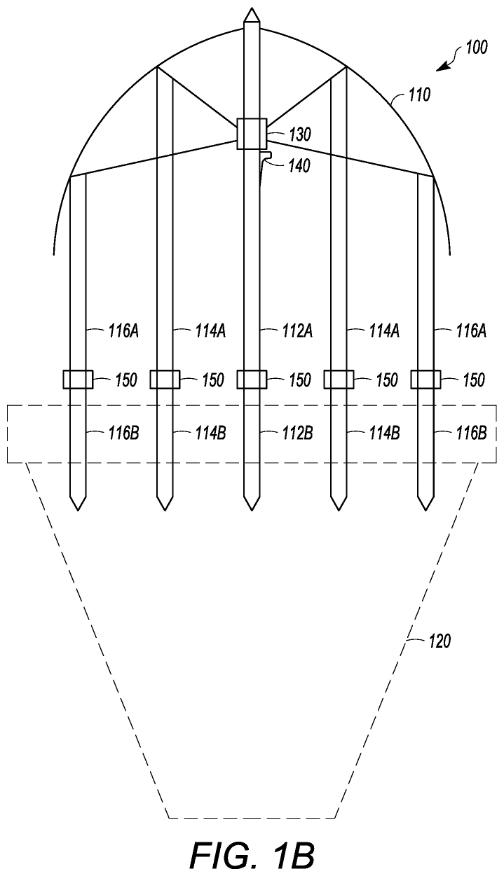

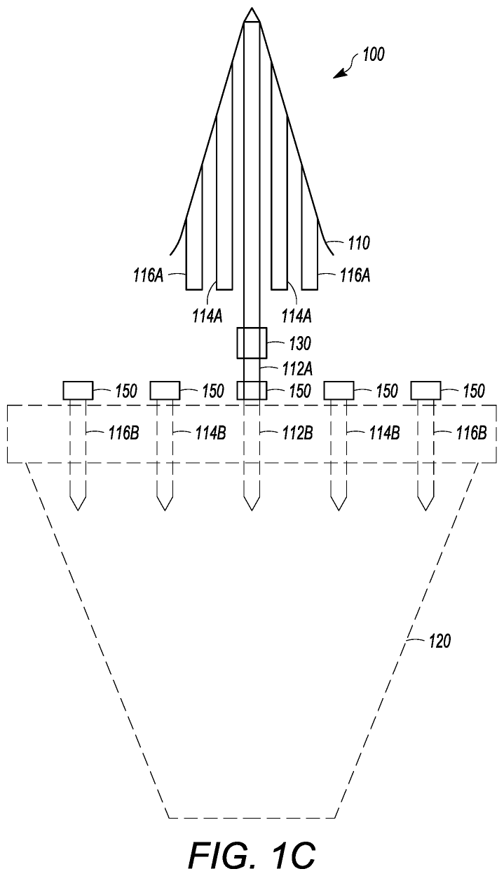

FIG. 1A shows a cut-away view of an exemplary temporary anchored weather covering 100 for a plant, in accordance with a first embodiment of the present invention.

In particular, as shown in FIG. 1A, an umbrella-shaped temporary anchored weather covering 100 is rapidly deployed and temporarily anchored in the dirt of a potted plant in a pot 120. The umbrella-shaped temporary anchored weather covering 100 includes a suitable weather covering 110 that covers a majority of a plant to be protected from sudden weather. The weather covering 110 is extended and pulled taught by sliding a sliding strut support 130 upward, beyond a post lock 140, so that struts 111 place pressure on the weather covering 110 so that the weather covering 110 becomes slightly stretched for stability.

Importantly, the rapidly deployable, temporary anchored weather covering 100 includes support legs 114 to provide structural support and stability to an area within the weather covering 100. An upper end of the support legs 114 are mounted to or otherwise support a corresponding strut 11, and a lower end of the support legs 114 is planted into the soil in the pot 120.

Also importantly, the rapidly deployable, temporary anchored weather covering 100 further includes anchoring legs 116 which are rapidly deployed into the soil in the pot 120 to temporarily anchor the rapidly deployable, temporary anchored weather covering 100 while in a deployed state.

In an undeployed state, the anchoring legs 116 and support legs 114 are removed from the soil in the pot 120. To this end the length of the anchoring legs 116 and the length of the support legs 114 may be shortened for retrieval from the deployed state.

In some embodiments the rapidly deployable, temporary anchored weather covering 100 may remain in the pot 120 with the center post 112 still anchored in the soil of the pot 120. Alternatively, the center post 112 may be extracted from the soil so that the rapidly deployable, temporary anchored weather covering 100 may be removed entirely and stowed nearby for later rapid deployment when severe weather again approaches or threatens plants growing in the pot 120.

FIG. 1B shows another embodiment of an exemplary rapidly deployable, temporary anchored weather covering 100 for a plant anchored using releasable legs.

In particular, as shown in FIG. 1B, anchoring of the rapidly deployable, temporary anchored weather covering 100 is facilitated by use of separable post junctions 150 which connect an upper center post 112a from a corresponding anchoring stake 112b; upper support legs 114a from corresponding anchoring stakes 114b; and upper anchoring legs 116a from corresponding anchoring stakes 116b. In this embodiment only the anchoring stakes 112b, 114b and 116b are secured in the ground, while the separable post junctions 150 are located at a surface of soil in the pot 120, or ideally located above the surface of the soil in the pot 120.

FIG. 1C shows the rapidly deployable, temporary anchored weather covering for a plant shown of FIG. 1B but shown in FIG. 1C in an unopened or undeployed state.

In particular, as shown in FIG. 1C, upper anchoring legs 116a and upper support legs 114a are disengaged from an upper portion of the respective separable post junction 150, and the sliding strut support 130 is unlocked and lowered on the upper center post 112a so that the weather covering 110 retracts and contracts and is no longer stretched. As shown in FIG. 1C the length of the upper anchoring legs 116a and upper support legs 114a is shortened, e.g., by telescoping upwards.

The upper center post 112a may either be left connected to the respective anchoring leg 112b so that the undeployed weather covering 110 is stowed in the pot 120 ready for another rapid deployment, or the upper center post 112a may be disconnected from the anchoring stake 112b so that the entire rapidly deployable, temporary anchored weather covering 100 for a plant may be stowed in a garden closet or elsewhere when undeployed.

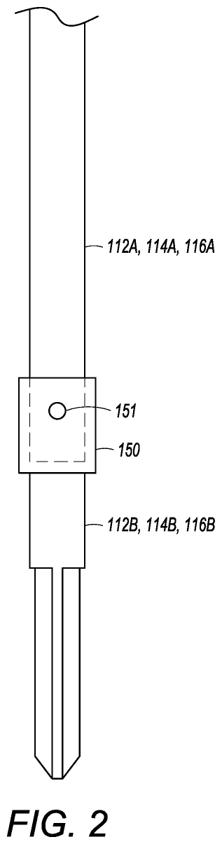

FIG. 2 shows exemplary detail of the releasable legs shown in FIGS. 1B and 1C.

In particular, as shown in FIG. 2, a releasable leg is formed by a separable post junction 150 mounted to each anchoring stake 112b, 114b, 116b. The separable post junction 150 includes a mounting feature such as a cylindrical cavity with a hole in which a pin on the upper center post 112a, a pin on the upper support leg 114a, and/or a pin on the upper anchoring leg 116a passes into. While a pin and hole locking mechanism is shown to secure the separable post junction 150 to the upper center post 112a, upper support leg 114a and/or the upper anchoring leg 116a, other types of junction and locking mechanism may be employed to hold the upper center post 112a, upper support leg 114a and/or upper anchoring leg 116a to an anchoring stake 112b, 114b, 116b.

The anchoring stake 112b, 114b, 116b is preferably a device which anchors more permanently in the soil in the pot 120, but which enables rapid deployment of the rapidly deployable, temporary anchored weather covering 100 thereinto.

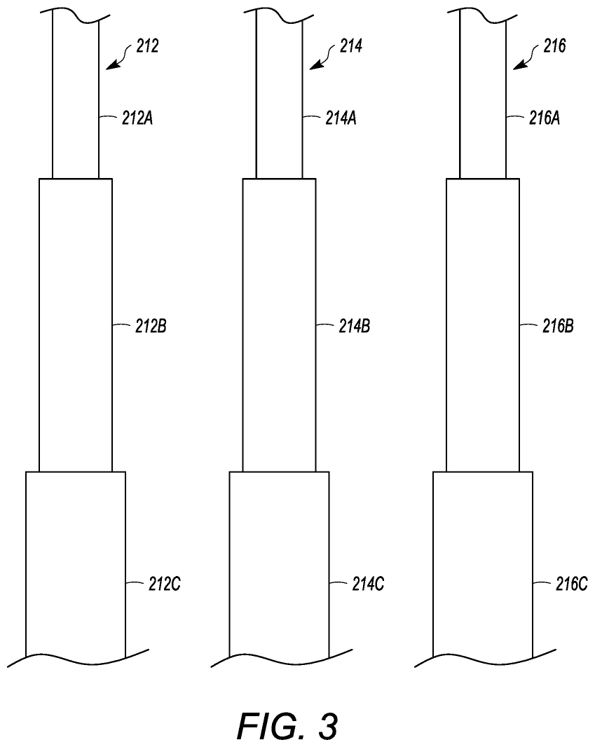

FIG. 3 shows telescoping legs of a temporary, anchored weather covering for a plant.

In particular, as shown in FIG. 3, any or all of the upper anchoring leg 116a or anchor leg 116; upper support leg 114a or support leg 114; and/or upper center post 112a or center post 112, may be adjustable in length, e.g., by telescoping leg portions of various diameters into one another. For instance, a telescoping center leg 212 may be formed by a smallest diameter leg portion 212a retracting into a central leg portion 212b, which in turn retracts into a largest diameter leg portion 212c. Likewise, a telescoping support leg 214 may be formed by a smallest diameter leg portion 214a retracting into a central leg portion 214b, which in turn retracts into a largest diameter leg portion 214c. Also, a telescoping anchoring leg 216 may be formed by a smallest diameter leg portion 216a retracting into a central leg portion 216b, which in turn retracts into a largest diameter leg portion 216c.

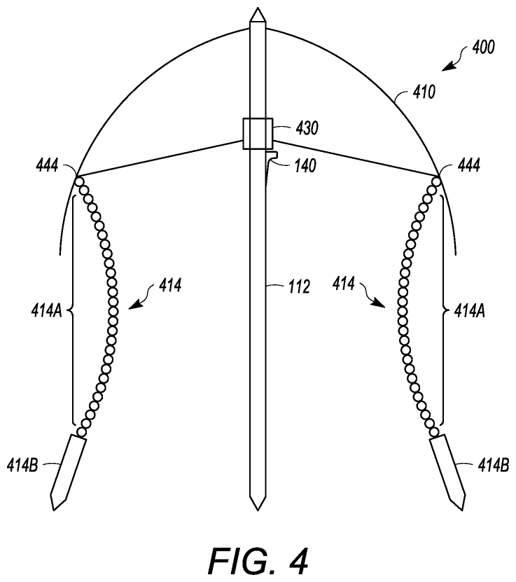

FIG. 4 shows another exemplary rapidly deployable, temporary anchored weather covering 400 for a plant including flexible anchoring legs 414, in accordance with another embodiment of the present invention.

In particular, as shown in FIG. 4, flexible anchoring legs 414 secure anchor points 444 on the weather covering 410 to ground or to a pot 120. Each flexible anchoring leg 414 preferably includes a flexible bendable portion 414a which may be shaped and hold its shape, and an anchoring stake 414b. The flexible bendable portion 414a preferably is bendable into any suitable shape as necessary to avoid interference or damage to a plant, and preferably holds its shape after being anchored to the ground via the anchoring stake 414b.

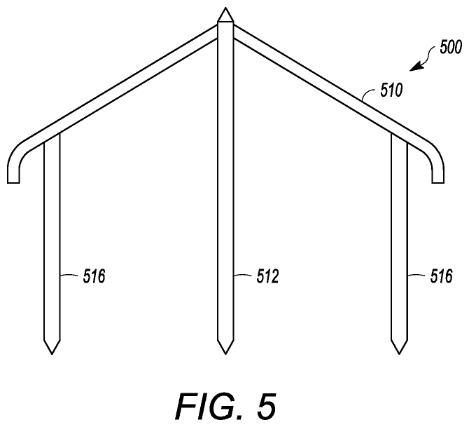

FIG. 5 shows a tent-shaped rapidly deployable, temporary anchored weather covering 500 for a plant, in accordance with another embodiment of the present invention.

In particular, as shown in FIG. 5, the weather covering 510 may be tent shaped to cover a larger area. However, importantly, the rapidly deployable, temporary anchored weather covering 500 as shown in FIG. 5 includes anchoring legs 516 to rapidly and temporarily anchor a perimeter of the weather covering 510 to the ground, or to the soil in a larger plant pot 120.

The anchoring legs 516 shown in FIG. 5 have an upper portion connected to a strut or other structure within the rapidly deployable, temporary anchored weather covering 500, and a lower portion which is driven into the soil to temporarily anchor the rapidly deployable, temporary anchored weather covering 500 until the threatening weather passes.

The anchoring legs 516 may be bendable, and/or include a separable post junction 150 to join to a suitable anchoring leg or other permanently placed junction to rapidly and temporarily accept a lower end of the anchoring legs 516 for rapid deployment of the rapidly deployable, temporary anchored weather covering 500 in accordance with other embodiments of the present invention.

Although not shown in FIG. 5, the rapidly deployable, temporary anchored weather covering 500 may include one or more sets of support legs.

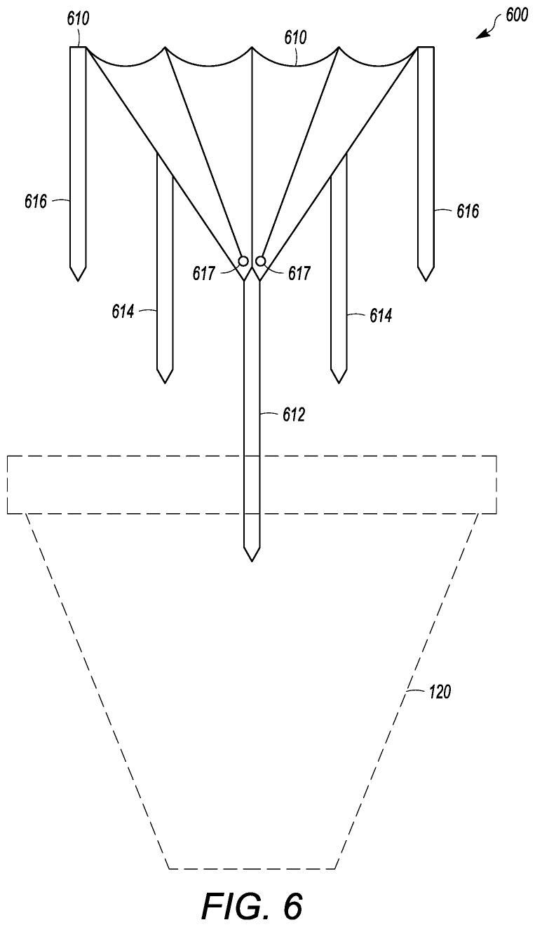

FIG. 6 shows an undeployed state of another exemplary rapidly deployable, temporary anchored weather covering 600 for a plant, in accordance with the present invention.

In particular, as shown in FIG. 6, the rapidly deployable, temporary anchored weather covering 600 is stored in an undeployed condition, with a center post 612 maintained in the ground, or soil in a plant pot 120. The weather covering 610 is shown to undeploy in an upward direction, with drainage openings 617 included to permit controlled directing of water down the center post 612 toward the soil.

The weather covering 610 may be held in the undeployed state by a suitable closing strap wrapped horizontally around the circumference of the undeployed weather covering 610, preferably at a middle point of the weather covering 610 in a vertical direction or above. Support legs 614 and temporary anchoring legs 616 may remain attached to struts or other structure on the underside of the weather covering 600 so as to facilitate rapid deployment when threatening weather approaches.

When threatening weather or other need approaches, the closing strap may be opened to allow the weather covering 610 to unfurl, and the support legs 614 and temporary anchoring legs 616 may be driven into the soil, or inserted into separable post junctions 150 connected to anchoring stakes 114b, 116b.

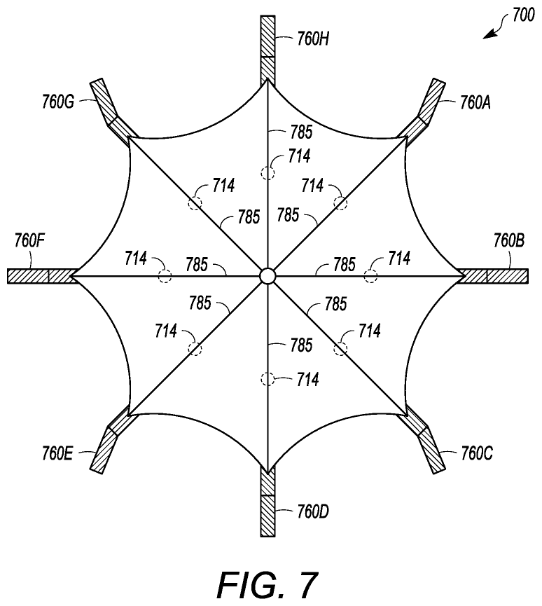

FIG. 7 shows a top view of attached anchoring straps 760a-760h (collectively referred to as 760) to anchor a rapidly deployable, temporary anchored weather covering 700, in accordance with another embodiment of the present invention.

In particular, as shown in FIG. 7, the rapidly deployable, temporary anchored weather covering 700 includes a weather covering 710 supported by underlying struts 785. Also underlying the weather covering 710 may be suitable support legs 714.

The weather covering 710 includes an anchoring strap 760 at multiple peripheral points along a circumference of an outer edge of the weather covering 710. As shown in FIG. 7 there is an anchoring strap 760 corresponding to each strut 785, though this need not be the case. Fewer or more anchoring straps 760 may be used, within the principles of the present invention.

The anchoring straps 760a-760h preferably include a quick-connect latch at a distal end to facilitate rapid anchoring when deploying the rapidly deployable, temporary anchored weather covering 700.

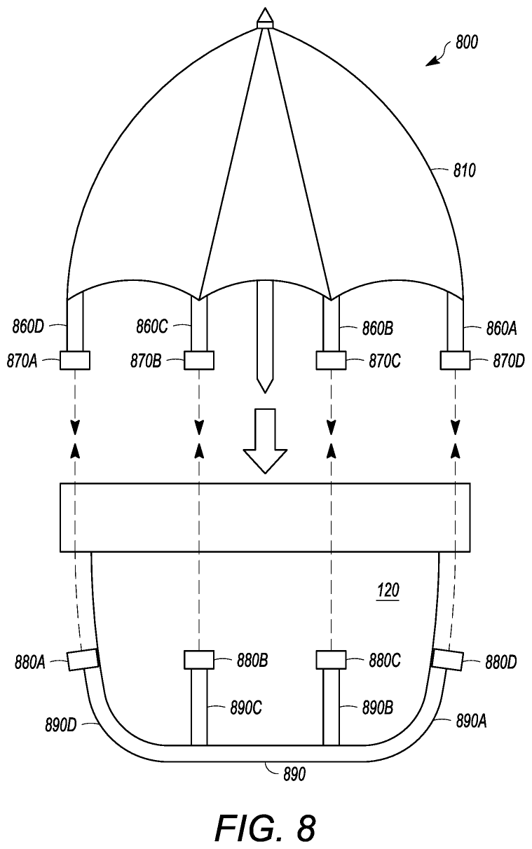

FIG. 8 shows an exemplary rapidly deployable, temporary anchored weather covering 800 including anchoring straps 860a-860d (collectively referred to as 860) that each have a quick-connect upper latching connector 870d-870a (collectively referred to as 870), in accordance with another embodiment of the present invention.

When deployed, each quick-connect upper latching connector 870d-870a mates with a corresponding quick-connect lower latching connector 880a-880d.

Each corresponding quick-connect lower latching connector 880a-880d is at a first distal end of a lower anchor strap 890d-890a (collectively 890). As shown in FIG. 8, the second distal ends of the lower anchor straps 890d-890a are interconnected under the pot 120 so as to provide a secure means to hold each upper anchor strap 860 in place when deployed. Also, the latching connection of the upper latching connector 870 and the lower latching connector 880 provides a secure means which is rapidly actionable for deployment.

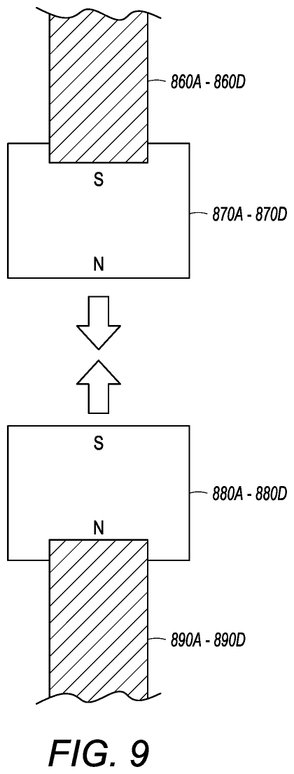

FIG. 9 shows further detail of an exemplary temporary quick-connect latch means of the attached anchoring straps shown in FIGS. 7-8.

In particular, as shown in FIG. 9, each of the upper anchor straps 860a-860d is connected to an exemplary quick-connect upper latching connector 870a-870d, and each of the lower anchor straps 890a-890d is connected to an exemplary quick-connect lower latching connector 880a-880d. The quick-connect upper latching connectors 870a-870d each include a magnet, preferably a “rare-earth” magnet for strength, with a given polarity. The rare-earth magnet may be mounted within a plastic housing which in turn connects directly to the upper anchor strap 860.

Similarly, the quick-connect lower latching connectors 880a-880d each also include a magnet, again preferably a “rare-earth” magnet for strength, with a given polarity configured opposite to the rare-earth magnet mounted in the quick-connect upper latching connectors 870. The rare-earth magnet may be mounted within a plastic housing which in turn connects directly to the upper anchor strap 860.

While it is preferred that both the upper latching connectors 870 and the lower latching connectors 880 include a “rare-earth” magnet, it is within the principles of the present invention that ordinary magnets may be used.

Moreover, while it is preferred that both the upper latching connectors 870 and the lower latching connectors 880 include a magnet, it is within the principles of the present invention for only one of the upper latching connectors 870 or the lower latching connectors 880 include a magnet, and the other include of be formed entirely of a ferrous metal so as to be attracted to the magnet in the other.

It is preferable, for rapid deployment purposes, that all latching connectors 870, 880 be of a similar design such that any upper latching connector 870a-870d may mate with any lower latching connector 880a-880d.

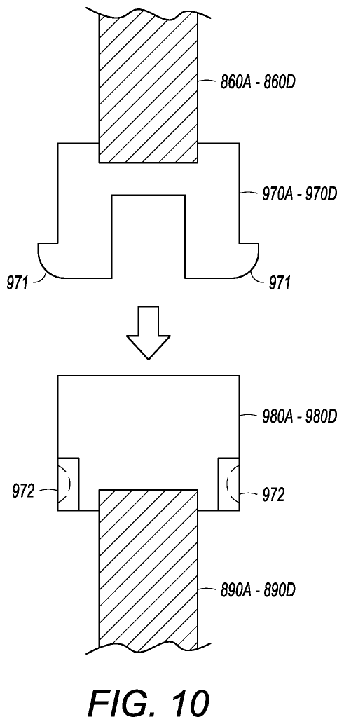

FIG. 10 shows further detail of another exemplary latch of the attached anchoring straps shown in FIGS. 7-8.

In particular, as shown in FIG. 10, a plastic upper latching connector 970a-970d includes springed tips 971 which depress while first inserted into the plastic lower latching connector 980a-980d, then become secured when the springed tips 971 are inserted fully such that they extend into matching latch points 972 in the lower latching connector 980a-980d.

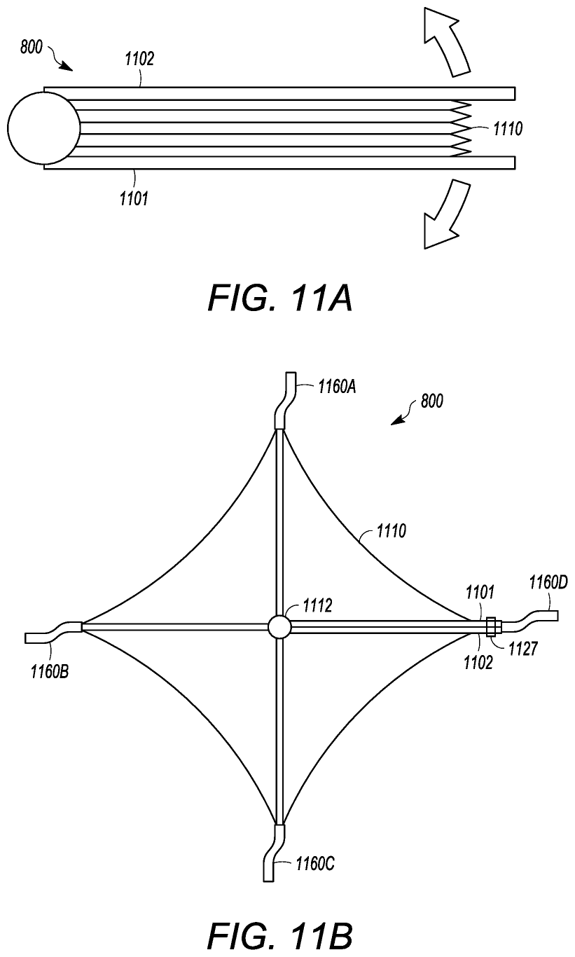

FIGS. 11A and 11B show another rapidly deployed, temporary anchored weather covering 800 for a plant having a rotating unfurl function, in accordance with yet another embodiment of the present invention.

In particular, as shown in FIG. 11A, an undeployed rapidly deployable, temporary anchored weather covering 800 is shown. The weather covering 1110 includes a split portion running from the center post 1112 to an anchor point connected to an anchor strap 1160d (FIG. 11B). The split portion includes a split rail comprising a first split rail 1101 and a mating second split rail 1102. In the undeployed state the entire weather covering 1110 is sandwiched between the first split rail 1101 and the second split rail 1102 as shown in FIG. 1A.

While undeployed, i.e. spiraled around, the first split rail 1101 may be secured to the second split rail 1102 with the weather covering 1110 therebetween using, e.g., a Velcro strap.

The rapidly deployable, temporary anchored weather covering 800 is stored in the undeployed state in location, with the center post 112 inserted into the soil of the plant or plants to be protected.

To deploy, the Velcro strap holding the first split rail 1101 to the second split rail 1102 with the weather covering 1110 therebetween is opened, and the first split rail 1101 is rotated horizontally, or spiraled, in the direction of the arrows in FIG. 11A, such that the first split rail 1101 is brought around to meet the second split rail 1102 as shown in FIG. 11B. The first split rail 1101 is then secured directly to the second split rail 1102 with a suitable strut-to-strut locking mechanism 1127, e.g., the same or another Velcro strap.

When deployed, the weather covering 1110 becomes stretched taught for stability. Importantly, anchoring straps 1160a-1160d, and/or anchoring legs (not shown) are exposed and secured to their respective anchoring points either in the soil or on mating lower connectors.

Specific additional details and additional embodiments shown and described with respect to any of the many exemplary embodiments shown herein of a rapidly deployable, temporary anchored coverings 100, 400, 500, 600, 700 and 800, many or most additional details are equally applicable to other embodiments of rapidly deployable, temporary anchored coverings 100, 400, 500, 600, 700 and 800 not shown or described therewith.

The reference numerals used throughout this specification and in the figures refer to:
11 strut
100 rapidly deployable, temporary anchored weather covering
110, 410, 510, 610, 710, 810, 1110 weather covering
112, 512, 612, 1112 center post
112a upper center post
112b, 114b, 116b anchoring stake
114, 614 support leg
114a upper support leg
116, 516, 616 anchoring leg
116a upper anchoring leg
120 plant pot
130, 430 sliding strut support
140 post lock
150 separable post junction
151 pin
212, 214, 216 telescoping leg
212a, 214a, 216a smallest diameter leg portion
212b, 214b, 216b central leg portion
212c, 214c, 216c largest diameter leg portion
400 rapidly deployable, temporary anchored weather covering
414 flexible anchoring leg
414a flexible bendable portion
414b anchoring stake
444 anchor point
500 rapidly deployable, temporary anchored weather covering
600 rapidly deployable, temporary anchored weather covering
617 drainage opening
700 rapidly deployable, temporary anchored weather covering
760a-760h anchor strap
785 strut
800 rapidly deployable, temporary anchored weather covering
860a-860d upper anchor strap
870a-870d upper latching connector
880a-880d lower latching connector
890a-890d lower anchor strap
970a-970b upper latching connector
971 springed tip
972 latch point
980a-980d lower latching connector
1101, 1102 horizontal strut
1127 strut-to-strut locking mechanism
1160a-1160d anchor strap

While the invention has been described with reference to the exemplary embodiments thereof, those skilled in the art will be able to make various modifications to the described embodiments of the invention without departing from the true spirit and scope of the invention.

What is claimed is:

1. A rapidly-deployable and temporarily anchoring weather covering for plants, comprising:
a deployable weather covering;
a strut structure under the deployable weather covering;
a plurality of support legs to support an inner area of the strut structure when the deployable weather covering is deployed; and
a plurality of anchor legs to temporarily anchor a respective plurality of perimeter anchor points of the deployable weather covering to a ground.

2. The rapidly-deployable and temporarily anchoring weather covering for plants according to claim 1, further comprising:
a plurality of anchor straps connected respectively to the plurality of perimeter anchor points to temporarily anchor the plurality of perimeter anchor points.

3. The rapidly-deployable and temporarily anchoring weather covering for plants according to claim 1, further comprising:
a plurality of quick-connect latches at respective ends of the plurality of anchor straps.

4. The rapidly-deployable and temporarily anchoring weather covering for plants according to claim 3, wherein:
the plurality of anchor straps temporarily anchor around a plant pot.

5. The rapidly-deployable and temporarily anchoring weather covering for plants according to claim 3, wherein:
the plurality of anchor straps temporarily anchor to respective plurality of anchoring stakes in the ground.

6. The rapidly-deployable and temporarily anchoring weather covering for plants according to claim 1, further comprising:
drainage openings in the weather covering.

7. The rapidly-deployable and temporarily anchoring weather covering for plants according to claim 6, wherein:
the drainage openings in the weather covering are located in a central area of the weather covering.

8. The rapidly-deployable and temporarily anchoring weather covering for plants according to claim 1, wherein:
the ground is contained in a plant pot.

9. A rapidly-deployable and temporarily anchoring weather covering for plants, comprising:
a deployable weather covering;
a strut structure under the deployable weather covering;
a center post to support the strut structure;
a plurality of anchor straps to temporarily anchor a respective plurality of perimeter anchor points of the deployable weather covering to a ground; and
a plurality of magnetic latches connected respectively to the plurality of anchor straps;
wherein when the deployable weather covering is in a deployed state the plurality of magnetic latches magnetically attach to a respective ferrous mating point.

10. The rapidly-deployable and temporarily anchoring weather covering for plants according to claim 9, wherein:
the ferrous mating point is another magnet oppositely attracted to the respective magnetic latch.

11. The rapidly-deployable and temporarily anchoring weather covering for plants according to claim 9, wherein:
the ferrous mating point is a rim of a metal plant pot.

12. The rapidly-deployable and temporarily anchoring weather covering for plants according to claim 9, wherein:
the ferrous mating point is attached to an anchoring stake secured in ground.

13. A rapidly-deployable and temporarily anchoring weather covering for plants, comprising:
a deployable weather covering that deploys in a spiral direction;
a strut structure under the deployable weather covering;
a center post to support the strut structure;
the strut structure including a first split strut and a second split strut which straddle a separation in the deployable weather covering, the first split strut and the second split strut sandwiching the deployable weather covering therebetween in an undeployed state, and the first split strut and the second split strut spiraling around a center post to directly mate with one another in a deployed state;
a plurality of anchor legs to temporarily anchor a respective plurality of perimeter anchor points of the deployable weather covering to a ground.

14. The rapidly-deployable and temporarily anchoring weather covering for plants according to claim 13, further comprising:
a plurality of anchor straps connected respectively to the plurality of perimeter anchor points to temporarily anchor the plurality of perimeter anchor points to the ground.

15. The rapidly-deployable and temporarily anchoring weather covering for plants according to claim 14, further comprising:
a plurality of quick-connect latches at respective ends of the plurality of anchor straps.

16. The rapidly-deployable and temporarily anchoring weather covering for plants according to claim 13, wherein:
the ground is contained in a plant pot.
